(19) United States
(12) Patent Application Publication
(10) Pub. No.: US 2011/0048685 A1
(43) Pub. Date: Mar. 3, 2011

(54) RADIATOR ASSEMBLIES

(76) Inventor: Anthony Cardno, Rotherham (GB)

(21) Appl. No.: 12/866,728

(22) PCT Filed: Feb. 16, 2009
(86) PCT No.: PCT/GB09/00418

§ 371 Date: Nov. 19, 2010

(30) Foreign Application Priority Data
Feb. 14, 2008 (GB) 0802691.6
Jul. 15, 2008 (GB) 0812860.5
Nov. 18, 2008 (GB) 0821074.2
Nov. 20, 2008 (GB) 0821238.3

(51) Int. Cl. F28D 1/00; F16L 29/00

(52) U.S. Cl. 165/148; 251/148

(57) ABSTRACT

An on-off valve (30) is for use in a radiator assembly (10). The on-off valve comprises a valve member (46) movable between on and off positions. The on-off valve further includes radiator connecting means (38) to connect the on-off valve to a radiator, and control valve connecting means (36) to connect the on-off valve to a radiator flow control valve (18 or 20).

This invention relates to radiator assemblies. More particularly, but not exclusively, this invention relates to valves for radiator assemblies. Embodiments of the invention relate to the use of valves in radiator assemblies, to methods of installing radiator assemblies and methods of removing radiators from radiator assemblies.

It is often necessary to remove radiators, for example during decorating. The removal of a radiator involves closing the control valve and the lock shield valve, loosening the bleed valve, and then detaching the radiator from the control valve and the lock shield valve. In order to prevent water and sludge in the radiator pouring onto the carpet, buckets or other receptacles need to be arranged under the radiator at the inlet and outlet. The radiator then has to be lifted carefully from its supports.

According to one aspect of this invention, there is provided a radiator assembly comprising a radiator having an inlet and an outlet for fluid, first and second flow control valves associated respectively with the inlet and the outlet to control the flow of fluid through the radiator, an on-off valve arranged between the first or second flow control valves and the inlet or outlet respectively, wherein the on-off valve has open and closed conditions, and is detachably connected to the first or second flow control valves, such that when the on-off valve is in the closed condition, the on-off valve can be detached from the first or second flow control valve.

According to another aspect of this invention, there is provided an on-off valve for use in a radiator assembly, the on-off valve comprising a valve member movable between on and off positions, and radiator connection means to connect the on-off valve to a radiator, and control valve connection means to connect the on-off valve to a radiator control means.

According to another aspect of this invention, there is provided the use of an on-off valve in a radiator assembly, said radiator assembly comprising a radiator having an inlet and an outlet for fluid, first and second flow control valves associated respectively with the inlet and the outlet to control the flow of fluid through the radiator, wherein the on-off valve is arranged between the first or second flow control valves and the inlet or outlet respectively, and the on-off valve has open and closed conditions, and is detachably connected to the first or second flow control valves, such that when the on-off valve is in the closed condition, the on-off valve can be detached from the first or second flow control valve.

According to another aspect of this invention, there is provided a method of installing a radiator assembly, said radiator assembly comprising a radiator having an inlet and an outlet for fluid, first and second flow control valves associated respectively with the inlet and the outlet to control the flow of fluid through the radiator, the method comprising arranging an on-off valve between the first or second flow control valves and the inlet or outlet respectively, connecting the on-off valve to the inlet or outlet of the radiator and detachably connecting the on-off valve to the first or second flow control valve, wherein the on-off valve has open and closed conditions, such that when the on-off valve is in the closed condition, the on-off valve can be detached from the first or second flow control valve.

According to another aspect of this invention, there is provided a method of removing from a radiator from a radiator assembly, said radiator assembly comprising a radiator having an inlet and an outlet for fluid, first and second flow control valves associated respectively with the inlet and the outlet to control the flow of fluid through the radiator, and an on-off valve arranged between the first or second flow control valves and the inlet or outlet respectively, the on-off valve having open and closed conditions, and the method comprises arranging the on-off valve in the closed condition, and detaching the on-off valve from the first or second flow control valve and thereafter removing the radiator.

Thus, in one embodiment, the detaching of the on-off valve from the flow control valve allows the radiator to be removed without material in the radiator exiting therefrom via the inlet or outlet at which the on-off valve is connected.

A first on-off valve may be arranged between the first flow control valve and the inlet, and a second on-off valve may be arranged between the second flow control valve and the outlet, wherein when first and second on-off valves are in their respective closed conditions, the first and second on-off valves can be detached from the first and second flow control valves respectively without material in the radiator exiting therefrom via the inlet or outlet.

In one embodiment, the radiator may comprise a main panel portion defining a space for the heating fluid to circulate. The radiator may comprise first and second fluid conduits to provide an inlet pipe and an outlet pipe for fluid to flow to and from the radiator. In this embodiment, a respective on-off valve may be provided in each of the first and second fluid conduits.

The first on-off valve may be detachably connected to the first flow control valve. The second on-off valve may be detachably connected to the second flow control valve.

In one embodiment, the method of installing the radiator assembly may comprise arranging the first on-off valve between the first flow control valve and the inlet, arranging the second on-off valve between the second flow control valve and the outlet. The method may further comprise connecting the first on-off valve to the inlet of the radiator, connecting the second on-off valve to the outlet of the radiator, detachably connecting the first on-off valve to the first flow control valve, and detachably connecting the second on-off valve to the second flow control valve.

The method of removing the radiator may comprise arranging the first and second flow control valves in the closed condition, thereafter detaching the first and second on-off valves from the first and second flow control valves, and thereafter removing the radiator.

The first flow control valve may comprise a manual control valve. The second flow control valve may comprise a lockshield valve.

The, or each, on-off valve may comprise a radiator connecting means to connect the on-off valve to the radiator. The, or each, on-off valve may comprise a control valve connecting means to connect the on-off valve to the respective flow control valve.

The radiator connecting means may comprise an end portion to co-operate with the radiator inlet or outlet. The end portion may be threaded to be threadably secured to the radiator. The end portion may be externally threaded to threadably engage internal threads on the radiator inlet or outlet.

The radiator connecting means may be configured to co-operate with connecting formations on the radiator. The radiator connecting means may be externally threaded to threadably engage corresponding threads on the radiator.

The radiator connecting means may include sealing means to seal the on-off valve to the radiator. The sealing means may comprise a boss to engage the radiator. The boss may surround the main body. The boss may comprise a flange extending around the main body. The flange may be circular, although the flange may be any other suitable shape.

The sealing means may further comprise a sealing member arrangeable between the boss and the radiator. The sealing member may comprise a resilient member, such as an O-ring seal.

The control valve connecting means may comprise an insertion member to be inserted into the respective flow control valve. The control valve connecting means may comprise a securing member to secure the on-off valve to the flow control valve. In one embodiment, the securing member is configured to secure the insertion member in the flow control valve.

The securing member may comprise threads to threadably engage corresponding threads on the flow control valve. The threads on the securing member may be internal threads. The securing member may comprise a nut.

The on-off valve may comprise a fluid flow conduit extending between the radiator connecting means and the control valve connecting means to provide fluid communication between the flow control valve and the radiator.

The on-off valve may comprise a ball valve. A valve member may be provided in the fluid flow conduit. The valve member may be a substantially spherical ball member having a fluid flow conduit therethrough.

The, or each, on-off valve may comprise a main body. The main body may define the fluid flow conduit. The main body may house the valve member.

The radiator connecting means may be provided at one end of the main body. The control valve connecting means may be provided at the opposite end of the main body.

The valve member may be movable, for example by rotation, between open and closed positions. The valve member may comprise an adjustment member to adjust the position of the valve member. The adjustment member may comprise a valve member turning element.

The main body may comprise a raised portion, and the adjustment member may be housed within the raised portion.

In one embodiment, the adjustment member may define a slot to receive an end of a screwdriver.

In another embodiment, the adjustment member may define a polygonal recess to receive an end of a key of a corresponding shape. The polygonal recess may be a hexagonal recess. The polygonal recess may be configured to receive an end region of a key of a polygonal profile. The method of removing the radiator may comprise a step of inserting the end region of the key into the polygonal recess and turning said key to move the valve member to the closed condition. The method of installing the radiator may comprise a step of inserting the end region into the polygonal recess and turning said key to move the valve to the open position.

The valve member may define a fluid flow opening alignable with the fluid flow conduit to allow fluid to flow through the valve. The valve member may comprise an occlusion region alignable with the fluid flow conduit to restrict fluid flow through the valve.

When the valve member is in the open position, the flow region may be aligned with the fluid flow conduit. When the valve member is in the open position, the occlusion region may be aligned with the fluid flow conduit.

The on-off valve may include a partial occlusion member on the main body to partially occlude the fluid flow conduit. The partial occlusion member may be arranged in the fluid flow conduit.

The partial occlusion member may define a fluid flow aperture to allow fluid to flow through the fluid flow conduit. The partial occlusion member may be arranged in the fluid flow conduit so that the fluid flow aperture is aligned with the fluid flow opening in the valve member when the valve member is in the open position, and so that the fluid flow aperture can be aligned with the occlusion region of the valve member, when the valve member is in the closed position.

The fluid flow opening in the valve member may be substantially the same width or diameter as the fluid flow aperture in the partial occlusion member. The occlusion region in the valve member may be the same width or diameter as the fluid flow aperture in the partial occlusion member.

The partial occlusion member may be provided on the main body, and may extend inwardly into the fluid flow conduit. The partial occlusion member may comprise an inwardly extending flange.

The fluid flow conduit may comprise first and second regions. The partial occlusion member may be arranged at the junction of the first and second regions. In one embodiment, the valve member is provided on one side of the partial occlusion member. In another embodiment, the valve member is provided on the opposite side of the partial occlusion member.

The on-off valve may be connectable to a drain conduit to allow fluid in the radiator to be drained therefrom. The drain conduit may be connected to the flow control valve connection means in fluid communication with the on-off valve, such that when the on-off valve is in the open condition, the fluid in the radiator can be drained therefrom.

If desired, a drain outlet may be provided on the on-off valve, the drain outlet being connectable to the drain conduit. The drain outlet may be arranged on the main body on the opposite side of the valve member to the radiator connection means.

The features described in the previous two paragraphs have the advantage in an embodiment of the invention that fluid in the entire central heating system can be drained from the system.

An embodiment of the invention will now be described by way of example only, with reference to the accompanying drawings, in which:

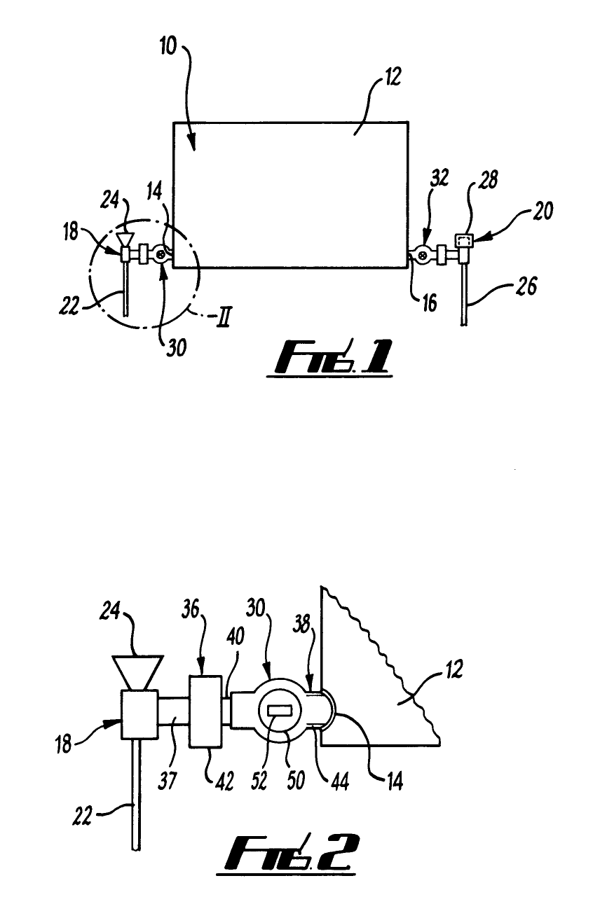

FIG. 1 is a front view of a radiator assembly;

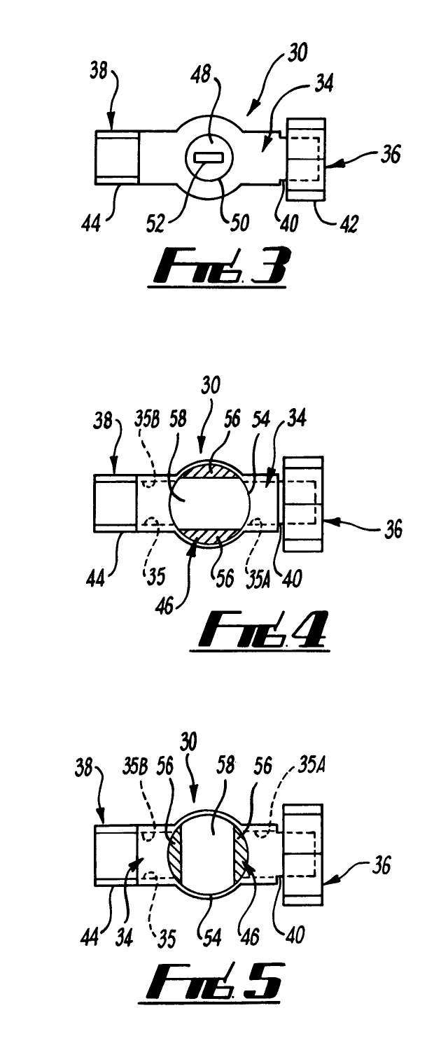

FIG. 2 is a close-up of the region marked II in FIG. 1

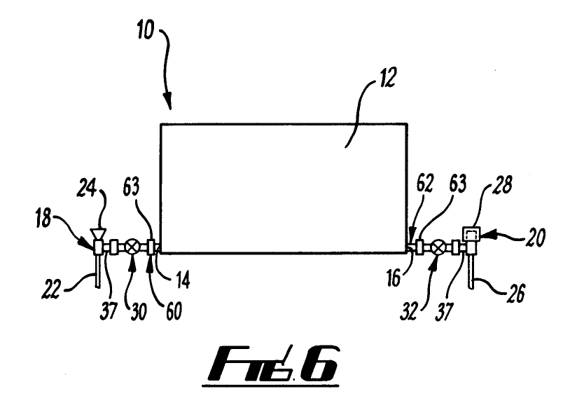

FIG. 3 is a front view of an on-off valve;

FIG. 4 is a part sectional front view of the on-off valve shown in FIG. 3 showing a valve member in an open position;

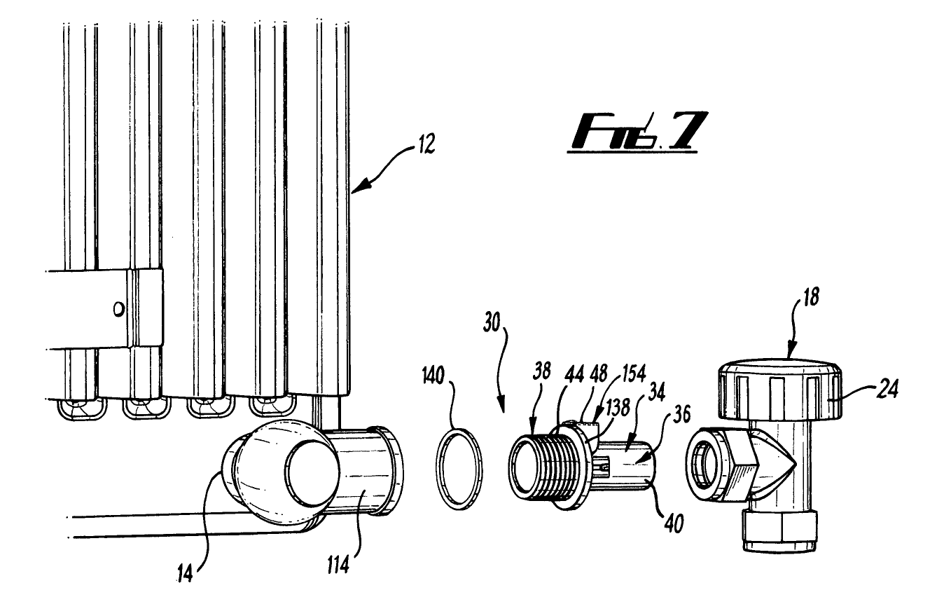

FIG. 5 is a part sectional front view of the on-off valve shown in FIG. 3 showing the valve member in a closed position;

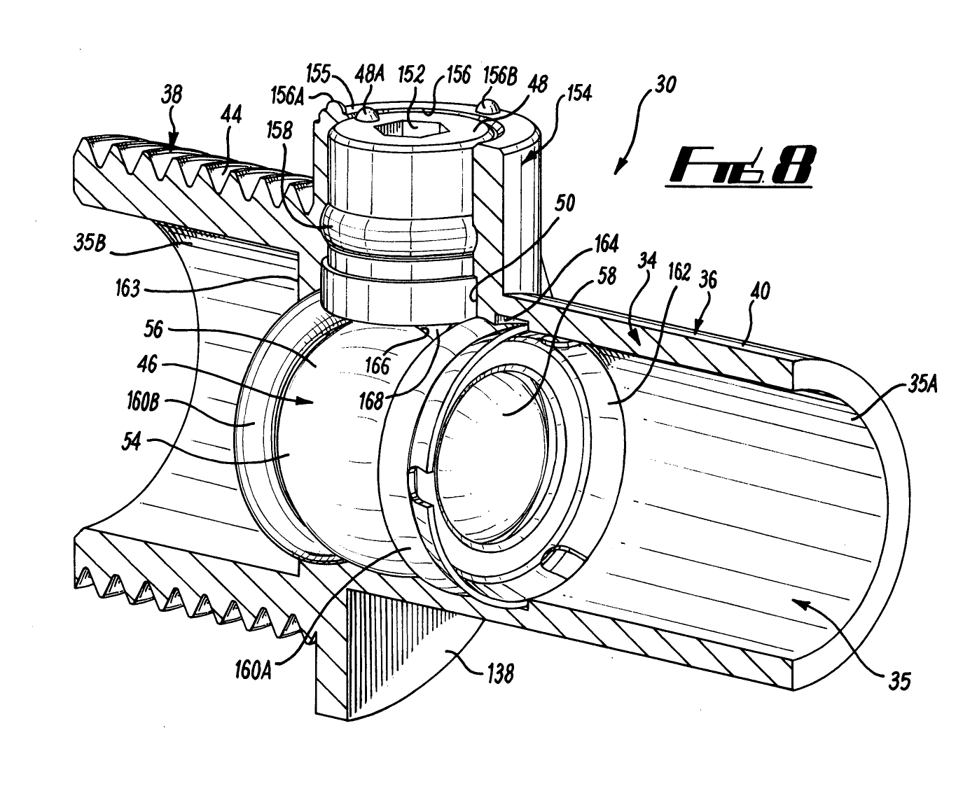

FIG. 6 is a view similar to FIG. 1 of an alternative embodiment of a radiator assembly; and

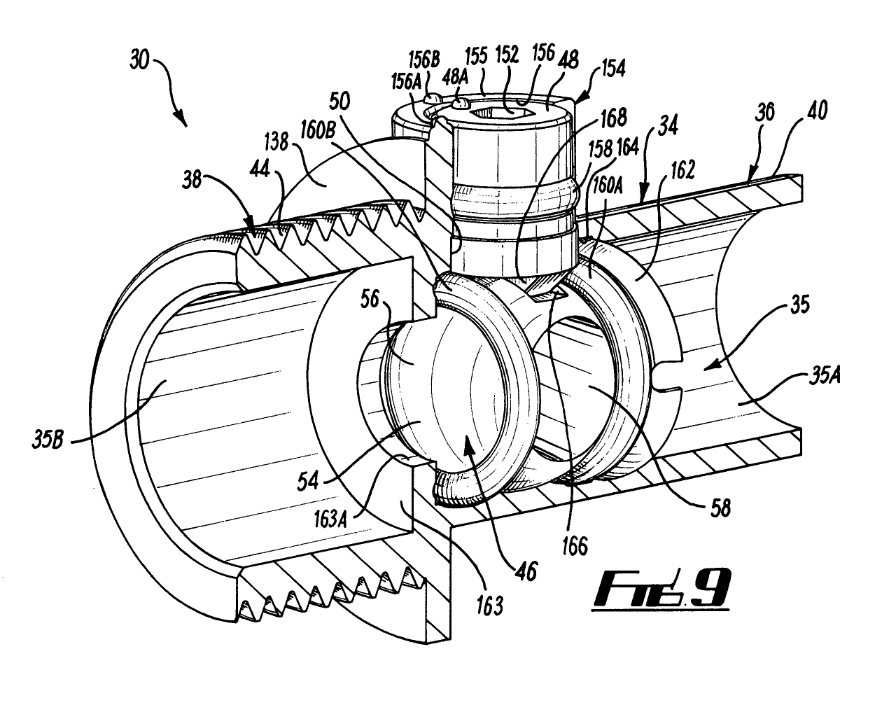

FIG. 7 is an exploded view of a further modification of an on-off valve to be mounted on a radiator;

FIG. 8 is a part sectional view of an on-off valve, with the valve member in an open condition;

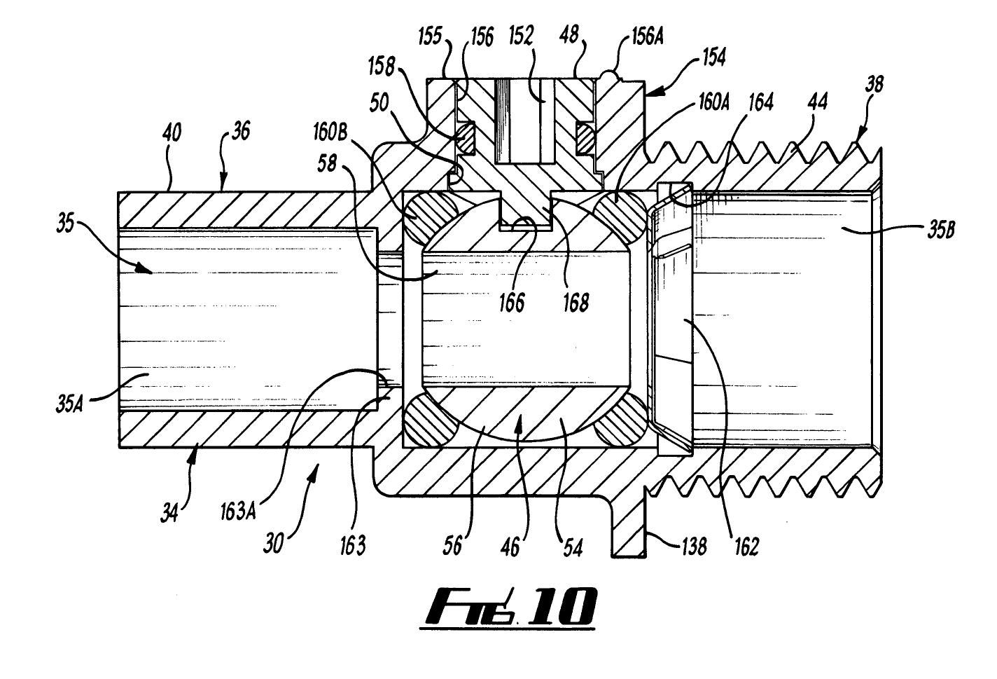

FIG. 9 is a part sectional view of the on-off valve shown FIG. 8 in a closed condition;

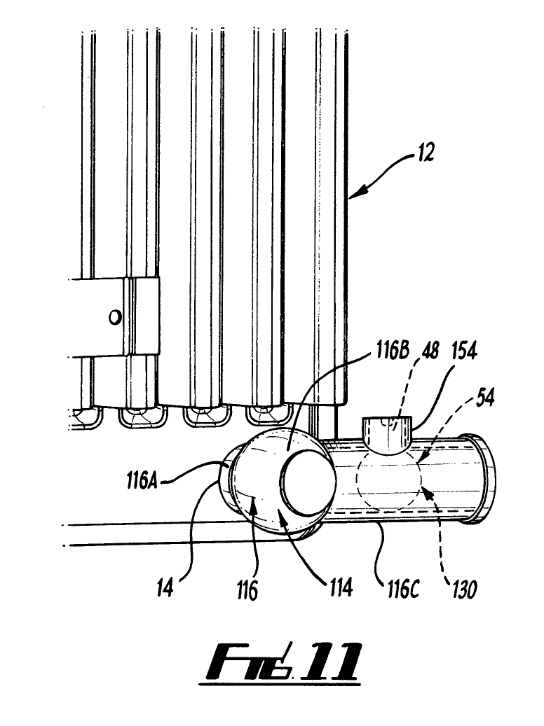

FIG. 10 is a sectional side view of an on-off valve similar to the valve shown in FIGS. 8 and 9 but with modifications; and

FIG. 11 shows a portion of a further embodiment of a radiator assembly.

Referring to FIG. 1, there is shown a radiator assembly 10 comprising a radiator 12 having an inlet 14 and an outlet 16. The radiator 12 is heated by the flow of a hot fluid, for example hot water, therethrough.

As shown in more detail in FIG. 2, a first flow control valve, in the form of a manual flow control valve 18, is provided at, and associated with, the inlet 14. The manual flow control valve 18 is connected via a pipe 22 to the heating pipe work of the building, and has a tap control member 24, which can be turned to control the flow of fluid into the radiator 12.

A first on-off valve 30 is connected to a spigot 37 on the manual control valve 18, and is secured to the radiator 12 at the inlet 14 by being screwed into the internal threads on the inlet 14. The first on-off valve 30 is arrangeable in open and closed conditions. When the first on-off valve 30 is in the open condition, fluid communication is provided between the manual control valve 18 and the radiator 12. When the first on-off valve 30 is in the closed condition, fluid is prevented from flowing into, or out of, the radiator 12 via the inlet 14.

A second flow control valve, in the form of a lockshield valve 20 is provided at, and associated with, the outlet 14. The lockshield valve 20 has a valve member which can be turned by a spanner or screwdriver to close the lockshield valve 20. The lockshield valve is connected via a pipe 26 to the heating pipe work in the building. A plastic cap 28 is generally provided over the lockshield valve 20.

The lockshield valve 20 is used to balance the flow of fluid through the radiator, and to close of the radiator 12 from the heating pipe work in the building when it is desired to remove the radiator 12.

It will be appreciated that, if desired, the manual flow control valve 18 can be provided at the outlet, and the lockshield valve 20 can be provided at the inlet.

A second on-off valve 32 is provided between the lockshield valve 20 and the radiator 12. The second on-off valve 32 is connected to the outlet 16 by being screwed in the internal threads on the outlet 16.

The second on-off valve 32 is arrangeable in open and closed conditions. When the second on-off valve 32 is in the closed condition, fluid communication is provided between the lockshield valve 20 and the radiator 12. When the second on-off out 32 is in the closed condition, fluid is prevented from flowing into, or out of, the radiator 12 via the outlet 16.

The first and second on-off valves the 30, 32 are detachably connected to the manual flow control valve 18 and the lockshield valve 20 respectively. When it is desired to remove the radiator, the manual control valve 18 and the lockshield valve 20 are closed. The first and second on-off valves 30, 32 can be arranged in their respective closed conditions to prevent fluid flowing out of the radiator 12 via the inlet 14 and the outlet 16. The radiator 12 can then be removed from the wall without any of the fluid in the radiator 12 flowing out via the inlet 14 or the outlet 16.

Referring to FIG. 3, there is shown the first on-off valve 30. It will be appreciated that the second on-off valve 32 is identical to the first on-off valve 30.

The first on-off valve 30 comprises a main body 34, a control valve connecting means 36 at one end of the main body 34, and a radiator connecting means 38 at the opposite end of the main body 34.

The main body 34 defines a fluid flow conduit 35 therethrough (shown in broken lines in FIGS. 4 and 5). The fluid flow conduit 35 provides fluid communication between the control valve connecting means 36 and the radiator connecting means 38. Hence, the flow conduit 35 provides fluid communication between the manual control valve 18 and the radiator 12.

The fluid flow conduit 35 has a first region 35A communicating with the flow control valve, and a second region 35B communicating with the radiator 12.

The control valve connecting means 36 comprises an insertion portion 40 for insertion into a spigot 37 on the manual control valve 18. A securing member in the form of an internally threaded nut 42 is provided on the insertion portion 40 to threadably engage corresponding external threads at the 14 on the spigot 37.

The radiator connecting means 38 comprises an externally threaded end portion 44 to threadably engage internal threads on the radiator outlet 16.

The main body 34 houses a valve member 46 shown in broken lines in FIG. 2. The valve member 46 has an adjustment member in the form of a valve member turning element 48, which extends through an aperture 50 in the main body 34.

In one embodiment, as shown in FIG. 3, the valve member turning element 48 defines a slot recess 52 to receive the end of a screwdriver so that the valve member turning element 48, and hence the valve member 46 can be turned, as described below.

Referring to FIGS. 4 and 5, there is shown the on-off valve 30, with a cut away region showing the valve member 46. As can be seen, the valve member 46 comprises a spherical member in the form of a ball member 54 having occlusion regions 56, and which defines a fluid flow opening 58 extending through the valve member 46. The valve member turning element 48 extends from the occlusion region of 56 through the main body 34.

FIG. 4 shows the valve member 46 in its open position, in which the fluid flow opening 58 is aligned with the fluid flow conduit 35. In this position, the fluid flow opening 58 provides fluid communication between the first region 35A and the second region 35B. Thus, when the valve member 46 is in its open position, fluid can flow through the on-off valve 30 between the manual control valve 18 and a radiator 12.

FIG. 5 shows the valve member 46 in its closed position in which the occlusion regions 56 extend across the fluid flow conduit 35, to prevent fluid flowing through the fluid flow conduit 35. In this position of the valve member 46, the fluid flow opening 58 is not aligned with the fluid flow conduit 35.

In order to install a radiator assembly 10 as described above, the first and second on-off valves 30, 32 are first connected to the inlet 14 and the outlet 16 respectively. The radiator connecting means 38 of each of the first and second on-off valves 30, 32 are secured to the inlet and outlet 14, 16 respectively. The radiator 12 with the first and second on-off valves 30, 30 connected is secured to the wall in the desired position, and the on-off valves 30, 32 are connected to the manual control valve 18 and the lockshield valve 20. In the case where the radiator is to be reconnected after removal, the first and second on-off valves 30, 32 can be arranged in their closed conditions before being connected to the manual control valve 18 and to the lockshield valve 20. When such connection has been achieved, the on-off valves 31, 32 can be moved to their open conditions.

In order to remove the radiator 12 from a radiator assembly 10, the manual control valve 18 and the lockshield valve 20 are first closed. Each of the first and second on-off valves 30, 32 are then arranged in their closed conditions, with the valve member 54 in the position shown in FIG. 4. The on-off valves 30, 32 are then detached from the manual control valve 18 and the lockshield valve 20. The radiator 12 can then be removed. If it is desired to replace the radiator, the steps above can simply be reversed.

There is thus described a novel and the inventive embodiment of the present invention, which facilitates the removal of a radiator on a wall of the building. In the embodiments described herein, on-off valves can be closed such that the radiator can be removed from the wall without the need to drain the radiator, and without any risk of material in the radiator pouring onto the carpet and ruining it.

The various modifications can be made without departing from the scope of the invention. For example the precise construction and operation of the valve member 54 may vary from the description above.

A further modification is shown in FIG. 6 which comprises many of the features of FIG. 1 above, and these features have been designated with the same reference numerals as in FIG. 1. The embodiment shown in FIG. 6 differs from the embodiment shown in FIG. 1 in that the embodiment shown in FIG. 6 comprises intermediate connecting conduit members 60, 62 secured to the inlet 14 and the outlet 16. The on-off valves 30, 32 are secured to the intermediate connecting conduit members 60, 62 respectively.

The end portions 44 on the on-off valves 30, 32 receive an insertion member on the intermediate connecting conduit members 60, 62. The external threads on the end portions 44 threadably engage internal threads on a securing member 63 on the intermediate connecting conduit members 60, 62.

Another modification is shown in FIGS. 7, 8 and 9, which comprises many of the features of the embodiment shown in FIGS. 3, 4 and 5. The features in FIGS. 7 to 9 which correspond to features in FIGS. 3, 4 and 5 are designated with the same reference numbers as in FIGS. 3, 4 and 5.

Referring to FIG. 7, it is seen that the radiator 12 comprises an inlet 14 to which is integrally attached, for example by welding, an inlet conduit 114. The inlet conduit is internally threaded and, as described below, can threadably receive the radiator connecting means 38 on the valve 30.

FIGS. 8 and 9 show that the first region 35A of the fluid flow conduit is narrower than the second region 35B. The valve member 46 is arranged in the first region 35A.

In the embodiment shown in FIGS. 7, 8 and 9, the valve member turning element 48 defines a hexagonal recess 152, suitable to receive a key (not shown) having a hexagonal end, such a key being known as a hex key or an alien key. This provides the advantage, in the embodiment shown in FIG. 7, that the hexagonal recess 152 can be accessed by an alien key even if the valve member turning element 48 faces the wall on which the radiator 12 is mounted, or if the valve member turning element faces the floor.

The main body 34 comprises a raised portion 154 in which the turning element 48 is housed. The raised portion has an upper edge 155 defining an aperture 156. First and second projections 156A and 156B are provided. A third projection 48A is provided on the turning element 48.

When the third projection 48A is aligned with the first projection 156A, as shown in FIG. 8, the valve member 46 is in its open position. When the third projection 48A is aligned with the second projection 156B, as shown in FIG. 9, the valve member 46 is in its closed position.

A first sealing member 158 is provided on the turning member 48 to provide a seal between the turning member 48 and the raised portion 154.

Two further sealing members 160A, 160B are provided opposite each other on the valve member 46 to provide a seal between the valve member 46 and the main body 34. A holding member 162 engages one of the sealing members 160 in the first region 35A of the fluid flow conduit 35, and the other sealing member 160B engages an inner flange 163.

The inner flange 163 is provided on the main body 34, and extends inwardly therefrom at the junction between the first and second regions 35A and 35B. A flow aperture 163A is defined centrally in the inner flange 163 to allow fluid to flow therethrough. The inner flange 163 separates the first region 35A of the fluid flow conduit 35 from the second region 35B.

A circular recess 164 is defined in the main body 34 in the first region 35A of the fluid flow conduit 35, and the holding member 162 is received in the circular recess 164.

The ball member 56 defines a slot 166, and the turning member 48 comprises a projecting co-operating member 168 received in the slot 166. Thus, when the turning member 48 is turned, the co-operating member 168 received in the slot 166, co-operates with the ball member 56 to turn the ball member 56.

When the radiator is to be removed, the end region of the hex key can be inserted into the hexagonal recess 152 and turned so that the on-off valves 30, 32 are moved to their closed conditions. The radiator can then be removed.

When it is desired to install a radiator, the on-off valves 30, 32 can be in their closed condition before installation and, after the on-off valves 30, 32 have been connected to the manual control valve 18 and to the lockshield valve 20, the end region of the hex key can be inserted in to the hexagonal recess. The hex key can then be turned to move the on-off valves 30, 32 to their open conditions, and allow hot water to flow through the radiator.

The radiator connecting means 38 comprises a sealing means in the form of a flange 138 extending around the main body 34. The flange 138 provides a seal against the radiator 12 to prevent leakage of water from the radiator.

The sealing means further includes a sealing member in the form of an O-ring seal 140 between the flange 138 and the radiator 12.

A modification of the on-off valve 30 shown in FIGS. 8 and 9 is shown in FIG. 10. In FIG. 10, the features that correspond to the features of FIGS. 8 and 9, and function in the same way, are given the same reference numerals in FIG. 10.

The modification of the on-off valve 30 shown in FIG. 10 differs from the valve 30 shown in FIGS. 8 and 9 in that second region 35B of the fluid flow conduit 35 is lengthened, and extends beyond the raised portion 154. In consequence of this, the first region 35A of the fluid flow conduit 35 is shortened.

Thus, the valve member 46 and the sealing members 160A and 160B are provided in the second region 35B, instead of in the first second region 35A, of the fluid flow conduit 35. With this arrangement, the circular recess 164 (which receives the holding member 162) is defined in the main body 34 in the second region 35B of the fluid flow conduit 35.

Since the valve member 46 is arranged in the wider of the first and second regions 35A and 35B of the fluid flow conduit 35, the valve member 46 in the embodiment shown in FIG. 10 is larger than the valve member 46 shown in FIGS. 8 and 9, for the same size on-off valve 30.

A further embodiment is shown in FIG. 11, which shows the radiator 12 having the inlet 14, and an inlet conduit 114 mounted integrally to the radiator 12 by suitable means such as welding. The inlet conduit 114 is provided with an on-off valve 130 therein.

As shown in FIG. 11, the inlet conduit 114 comprises a fluid flow pipe 116 comprising a first pipe portion 116A mounted on the radiator 12. The first pipe portion 116A extends from the radiator to a generally spherical portion 116B. A second pipe portion 116C extends from the spherical portion 116B substantially orthogonally to the first pipe portion 116A.

An on-off valve 130 is provided in the second pipe portion 116C, and comprises a valve member 54 in the second pipe portion 116C. A raised portion 154 extends upwardly from the second pipe portion 116C to house the turning member 48.

The on-off valve 130 has a similar construction to the on-off valve 30 shown in FIGS. 7, 8 and 9, differing in that the second pipe portion 116C provides the main body of the on-off valve 130.

1. An on-off valve for use in a radiator assembly, the on-off valve comprising a valve member movable between on and off positions, and radiator connecting means to connect the on-off valve to a radiator, and control valve connecting means to connect the on-off valve to a radiator flow control valve.

2-72. (canceled)

73. An on-off valve according to claim 1 comprising a main body defining a fluid flow conduit extending between the radiator connecting means and the control valve connecting means to provide fluid communication between the flow control valve and the radiator,

74. An on-off valve according to claim 73, wherein the main body houses the valve member in the fluid flow conduit, the radiator connecting means being provided at one end of the main body, and the control valve connecting means being provided at the opposite end of the main body.

75. An on-off valve according to claim 74, wherein, the radiator connecting means comprises an end portion to cooperate with the radiator inlet or outlet, the end portion being threaded to be threadably secured to the radiator.

76. An on-off valve according to claim 75, wherein the end portion is externally threaded to threadably engage internal threads on the radiator inlet or outlet.

77. An on-off valve according to claim 73, wherein the radiator connecting means comprises sealing means to seal the on-off valve to the radiator, the sealing means comprising a boss to engage the radiator, the boss comprising a flange extending around the main body.

78. An on-off valve according to claim 73, wherein the control valve connecting means comprises an insertion member to be inserted into the flow control valve, and a securing member to secure the on-off valve to the flow control valve, the securing member comprising threads to threadably engage corresponding threads on the flow control valve.

79. An on-off valve according to claim 73 comprising a ball valve, with the valve member provided in the fluid flow conduit, the valve member being a substantially spherical ball member having a fluid flow passage therethrough, wherein the valve member is rotatably movable between open and closed positions, and the valve member comprises an adjustment member to adjust the position of the valve member.

80. An on-off valve according to claim 79, wherein the main body comprises a raised portion, and the adjustment member is housed within the raised portion.

81. An on-off valve according to claim 80, wherein the adjustment member defines a recess said recess being one selected from: a slot to receive an end of a screwdriver; and a polygonal recess to receive an end of a key of a of a corresponding polygonal profile.

82. An on-off valve according to claim 73, wherein the valve member defines a fluid flow opening alignable with the fluid flow conduit to allow fluid to flow through the valve, and the valve member further including an occlusion region alignable with the fluid flow conduit to restrict fluid flow through the valve and wherein, when the valve member is in the on position, the flow region is aligned with the fluid flow conduit, and when the valve member is in the off position, the occlusion region is aligned with the fluid flow conduit.

83. An on-off valve according to claim 73 including a partial occlusion member on the main body to partially occlude the fluid flow conduit, the partial occlusion member defining a fluid flow aperture to allow fluid to flow through the fluid flow conduit.

84. An on-off valve according to claim 83, wherein the partial occlusion member is arranged in the fluid flow conduit so that the fluid flow aperture is aligned with the fluid flow opening in the valve member when the valve member is in the open position, and so that the fluid flow aperture can be aligned with the occlusion region of the valve member, when the valve member is in the closed position.

85. An on-off valve according to claim 83, wherein the fluid flow opening in the valve member is substantially the same width or diameter as the fluid flow aperture in the partial occlusion member, and the occlusion region in the valve member is the same width or diameter as the fluid flow aperture in the partial occlusion member.

86. An on-off valve according to claim 83, wherein the partial occlusion member is provided on the main body, and comprises an inwardly extending flange which extends inwardly into the fluid flow conduit.

87. An on-off valve according to claim 73, wherein the on-off valve include a drain outlet connectable to a drain conduit to allow fluid in the radiator to be drained therefrom, the drain conduit being arranged on the main body on the opposite side of the valve member to the radiator connecting means, and being connected to the flow control valve connecting means in fluid communication with the on-off valve, such that when the on-off valve is in the open condition, the fluid in the radiator can be drained therefrom.

88. A radiator assembly comprising a radiator having an inlet and an outlet for fluid, first and second flow control valves associated respectively with the inlet and the outlet to control the flow of fluid through the radiator, an on-off valve as claimed in claim 1 arranged between the first or second flow control valves and the inlet or outlet respectively, wherein the on-off valve is detachably connected to the first or second flow control valves, such that when the on-off valve is in the closed condition, the on-off valve can be detached from the first or second flow control valve.

89. A radiator assembly according to claim 88, wherein the radiator comprises a main panel portion defining a space for the heating fluid to circulate, and first and second fluid conduits to provide an inlet pipe and an outlet pipe for fluid to flow to and from the radiator, wherein a respective one of the on-off valves is provided in each of the first and second fluid conduits, each on-off valve defining a fluid flow conduit to provide fluid communication between the flow control valve and the main panel.

90. A radiator assembly according to claim 88, wherein the on-off valve is connectable to a drain conduit to allow fluid in the radiator to be drained therefrom, the drain conduit being connected to the flow control valve connecting means in fluid communication with the on-off valve, such that when the on-off valve is in the open condition, the fluid in the radiator can be drained therefrom.

91. A radiator assembly according to claim 90, including a drain outlet provided on the on-off valve, the drain outlet being connectable to the drain conduit and being arranged on the main body on the opposite side of the valve member to the radiator connecting means.
